(19) United States
(12) Patent Application Publication
(10) Pub. No.: US 2026/0045507 A1
(43) Pub. Date: Feb. 12, 2026

(54) ELECTRODE PRECURSOR COMPOSITION

(71) Applicant: Dyson Technology Limited, Malmesbury, Wiltshire (GB)

(72) Inventors: Alex MADSEN, Swindon (GB); Daniel Stephen MACPHERSON, Trowbridge (GB); Qiaochu TANG, Oslo (CA); Milan CHROMEK, Oxford (GB)

(21) Appl. No.: 19/099,307

(22) PCT Filed: Jul. 25, 2023
(86) PCT No.: PCT/IB2023/057542

§ 371 Date: Jan. 28, 2025

(30) Foreign Application Priority Data
Jul. 29, 2022 (GB) 2211089.4

(51) Int. Cl. H01M 4/62; C08J 5/18; C08K 3/04; C08K 3/30; C08K 3/38; C08K 5/3445; C08K 5/42; C08L 27/16; C08L 33/12; H01M 4/131; H01M 10/0525

(52) U.S. Cl. CPC H01M 4/623; C08J 5/18; C08K 3/04; C08K 3/30; C08K 3/38; C08K 5/3445; C08K 5/42; C08L 27/16; C08L 33/12; H01M 4/131; H01M 4/62; H01M 4/625; H01M 10/0525; C08J 2327/16; C08J 2333/12; C08J 2427/16; C08K 2201/001; C08K 2201/014; C08L 2203/16; C08L 2203/20; C08L 2205/025; C08L 2205/03

(57) ABSTRACT

An electrode precursor composition for an alkali metal ion secondary cell, for example a lithium-ion secondary cell, is described. The electrode precursor composition includes a polymer-electrolyte gel matrix phase and a dispersed phase containing an electrochemically active material. The electrode precursor composition may be processed into an electrode.

### FIELD OF THE INVENTION

The present invention relates to an electrode precursor composition for an alkali metal ion secondary cell. The invention also relates to electrodes, cells and energy storage devices made from such precursor compositions, along with methods of preparing electrodes for alkali metal ion secondary cells.

### BACKGROUND OF THE INVENTION

Lithium-ion secondary batteries are the leading battery technology currently used in applications from small personal devices to electric vehicles. Lithium-ion batteries are favoured for their high energy density and long cycle life, among other benefits. They contain a plurality of lithium-ion secondary cells, which is one example of an alkali metal ion secondary cell.

Traditional lithium-ion battery components such as electrodes are made from a solvent cast process that uses sacrificial solvent. This is an energetically expensive step, and a process that avoids using sacrificial solvent is therefore desirable.

A further major drawback of lithium-ion technology and other alkali-metal ion secondary cell technology is that a liquid electrolyte is often used within the lithium-ion cells of the battery, to provide conductivity of lithium ions within the cell between the solid, solvent cast anode and cathode. This causes safety problems since the liquid electrolytes are often highly flammable. This is a particular problem for electric vehicles, where a collision with another vehicle may be relatively likely and the resulting impact may cause damage to the battery and ignition of the electrolyte. It is also a problem for devices used in the home, where a lithium-ion battery fire could cause damage to property or serious injury.

One approach to avoiding the use of sacrificial solvent, and the need for liquid electrolyte within the cell, is preparing gel electrodes. These electrodes can be formed from a composition prepared by mixing the necessary components such as electrochemically active material, polymer, and a liquid electrolyte, and subsequently subjecting the composition to a thermal treatment.

The choice of polymer for use in the gel electrode can lead to problems during the operation of the cell. The gel electrode composition contains a small amount of liquid electrolyte to aid gelation of the polymer, so it is beneficial for the polymer to have some solubility in this electrolyte so that a gel may more easily form and the processability of the gel electrodes is improved, reducing the cost of manufacture. However this in turn makes the finished gel electrode more prone to dissolution in the electrolyte which is present between the electrodes within the finished cell, reducing the operable lifetime of the cell. By contrast, polymers having poor solubility in electrolyte may ensure that, once assembled, the gel electrodes are not degraded by the electrolyte present in the cell. However such electrodes are very difficult to manufacture due to the poor gelation between the polymer and the electrolyte

There is a need for gel electrode precursor compositions which are both easier to process and provide robust electrodes which facilitate good cell lifetime.

### SUMMARY OF THE INVENTION

The invention relates generally to an electrode precursor composition for an alkali metal ion secondary cell, and in particular to an electrode precursor composition comprising a polymer-electrolyte gel matrix phase comprising a blend of polymers.

A first aspect of the invention is an electrode precursor composition for an alkali metal ion secondary cell, comprising:
a polymer-electrolyte gel matrix phase comprising a blend of a first polymer, a second polymer different from the first polymer, and a liquid electrolyte; and
a dispersed phase comprising an electrochemically active material;
   wherein the liquid electrolyte comprises an organic solvent and an alkali metal salt;
   wherein the first polymer has a solubility in the liquid electrolyte which is higher than the solubility of the second polymer in the liquid electrolyte; and
   wherein the volume ratio of the first polymer to the second polymer is from 0.2 to 7.

The electrode precursor composition finds use as a precursor material for the preparation of a gel electrode.

The electrode precursor composition contains a polymer-electrolyte gel matrix phase which comprises a blend of a first polymer, a second polymer different from the first polymer, and a liquid electrolyte. The liquid electrolyte contains an organic solvent and the first polymer has a solubility in the liquid electrolyte which is higher than the solubility of the second polymer in the liquid electrolyte. In this way, the electrode precursor composition provides a balance between processability, through the presence of the more soluble polymer, and durability during use of the cell, through the presence of the less soluble polymer. The more highly soluble (first) polymer enables the formation of a more easily processible gel during manufacture of the gel electrodes. The less highly soluble (second) polymer is less prone to dissolution into the cell electrolyte during use of the cell and therefore ensures good cell lifetime.

Furthermore, the volume ratio of the first polymer to the second polymer is from 0.2 to 7. Within this range a good balance of processability and durability is obtained by the polymer blend.

A further benefit of the electrode precursor composition is that the concentration of the alkali metal salt in the overall composition is higher than would otherwise be possible without the presence of the polymer blend. A higher salt concentration increases the conductivity of the gel electrode, improving electrochemical performance of the cell. Due to the presence of the first, more soluble polymer in the blend, a greater quantity of the liquid electrolyte can be incorporated into the electrode precursor composition, while the presence of the second polymer ameliorates any detrimental effect on structural stability of the electrode. The greater quantity of liquid electrolyte means a higher salt concentration and consequently improved electrode performance, without any noticeable effect on electrode structural stability.

The dissolution of the first polymer in the liquid electrolyte occurs at a temperature of at least 30° C., or at least 50° C. or at least 80° C.) and forms a gel which is very stable at room temperature.

A second aspect of the invention is an electrode for use in an alkali metal ion secondary cell comprising:
a polymer-electrolyte gel matrix phase comprising a blend of a first polymer, a second polymer different from the first polymer, and a liquid electrolyte; and
a dispersed phase comprising an electrochemically active material;
   wherein the liquid electrolyte comprises an organic solvent and an alkali metal salt;
   wherein the first polymer has a solubility in the liquid electrolyte which is higher than the solubility of the second polymer in the liquid electrolyte; and
   the volume ratio of the first polymer to the second polymer is from 0.2 to 7.

A third aspect of the invention is a method of producing an electrode comprising processing an electrode precursor composition according to the first aspect to form a film or coating.

A fourth aspect of the invention is an electrochemical secondary cell comprising an electrode according to the second aspect.

A fifth aspect of the invention is an electrochemical energy storage device comprising an electrochemical secondary cell according to the fourth aspect.

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

In some embodiments the electrochemically active material makes up from 50 to 75 vol % of the electrode precursor composition, for example from 50 to 70 vol %, from 50 to 69 vol %, from 50 to 68 vol %, from 55 to 68 vol %, from 58 to 68 vol % or from 60 to 68 vol %.

In some embodiments the electrochemically active material makes up from 62 to 75 vol % of the electrode precursor composition, for example from 62 to 70 vol %, from 62 to 69 vol %, from 62 to 68 vol % or from 64 to 69 vol %.

In some embodiments, the dispersed phase further comprises a conductive additive. This may be a particulate conductive additive.

In some embodiments, the conductive additive comprises or consists of one or more forms of carbon. In some embodiments, the conductive additive comprises or consists of one or more of carbon black, graphite and other forms of carbon. In some embodiments, the conductive additive comprises or consists of one or more of carbon black and graphite. In some embodiments, the conductive additive comprises or consists of carbon black. Examples of commercially available carbon black include Ketjen Black and Super C65.

In some embodiments, the conductive additive is present in an amount of from 0.2 wt % to 2.5 wt %, based on the total weight of electrode precursor composition, for example from 0.5 wt % to 2.5 wt %.

In some embodiments, the conductive additive is present in an amount of from 0.3 vol % to 2.5 vol %, based on the total weight of electrode precursor composition, for example from 0.5 vol % to 2.5 vol %, from 0.5 vol % to 2.4 vol %, from 0.5 vol % to 2.3 vol %, from 0.5 vol % to 2.2 vol %, from 0.5 vol % to 2.1 vol % or from 0.9 vol % to 1.5 vol %.

In some embodiments, the dispersed phase comprises from 1.2 vol % to 4 vol % of the conductive additive, based on the total volume of the dispersed phase, for example from 1.2 vol % to 3.9 vol %, from 1.2 vol % to 3.8 vol %, from 1.2 vol % to 3.7 vol %, from 1.2 vol % to 3.6 vol %, from 1.2 vol % to 3.5 vol % or from 1.4 vol % to 2.0 vol %.

In some embodiments, the dispersed phase comprises from 96 vol % to 99 vol % of the electrochemically active material, based on the total volume of the dispersed phase, for example from 97 vol % to 98.9 vol %, from 97 vol % to 98.8 vol %, from 97.5 vol % to 99 vol %, from 98 vol % to 99 vol % or from 98.4 vol % to 98.6 vol %.

The dispersed phase may consist of the electrochemically active material and the conductive additive. In some embodiments the dispersed phase consists of the electrochemically active material and carbon black.

In some embodiments, the polymer-electrolyte gel matrix phase comprises a mixture of a blend of the first and second polymers and a liquid electrolyte, wherein the weight ratio of electrolyte: polymer blend is from 2 to 10, for example from 2 to 6.

In some embodiments, the electrode precursor composition comprises the polymer blend in an amount of from 2 to 10 vol %, based on the total volume of electrode precursor composition, for example from 2 to 9 vol %, from 2 to 8 vol %, from 3 to 8 vol % or from 3 to 5 vol %.

In some embodiments, the polymer-electrolyte gel matrix phase comprises the polymer blend in an amount of from 5 to 30 vol %, based on the total volume of polymer-electrolyte gel matrix phase, for example from 5 to 25 vol %, from 8 to 24 vol %, from 10 to 24 vol %, from 10 to 23 vol %, from 10 to 22 vol %, or from about 10 to 15 vol %.

In some embodiments, the polymer-electrolyte gel matrix phase comprises the liquid electrolyte in an amount of from 70 to 95 vol %, based on the total volume of polymer-electrolyte gel matrix phase, for example from 75 to 90 vol %, from 85 to 90 vol %, or from 87 to 89 vol %.

In some embodiments, the electrode precursor composition comprises the liquid electrolyte in an amount of from 20 to 35 vol %, based on the total volume of electrode precursor composition, for example from 21 to 34 vol %, from 22 to 33 vol %, from 23 to 32 vol % or from 24 to 32 vol %.

As explained above, the present invention allows the amount of liquid electrolyte present to be increased while maintaining good structural stability of the gel electrode. So, in some embodiments, the liquid electrolyte makes up at least 31 vol % of the electrode precursor composition, for example greater than 31 vol %, for example greater than 31.00 vol %, for example from greater than 31 vol % to 35 vol %. Compositions containing a single type of polymer which provides the necessary structural stability are unable to incorporate such levels of electrolyte. By contrast, compositions containing a single type of polymer which is able to incorporate such levels of electrolyte do not provide the necessary structural stability and the electrodes are degraded by the cell electrolyte during use, shortening the lifetime of the cell. The invention allows for a higher level of liquid electrolyte in the gel electrode (and thereby a higher level of alkali metal salt), while maintaining good structural stability.

In some embodiments, the polymer-electrolyte gel matrix phase consists of the gelling polymer blend and the liquid electrolyte.

In some embodiments, the liquid electrolyte comprises or consists of an organic solvent comprising one or more cyclic or linear carbonate compounds. In some embodiments the solvent comprises one or more cyclic carbonate compounds. In some embodiments the solvent comprises one or more of ethylene carbonate, propylene carbonate, dimethyl carbonate, diethyl carbonate, ethyl-methyl carbonate, butylene carbonate, vinylene carbonate, fluoroethylene carbonate, fluoropropylene carbonate and γ-butyrolactone.

In some embodiments the solvent comprises one or more of ethylene carbonate, propylene carbonate, vinylene carbonate and fluoroethylene carbonate. In some embodiments the solvent comprises or consists of a mixture of ethylene carbonate, propylene carbonate, vinylene carbonate and fluoroethylene carbonate.

In some embodiments the solvent comprises a blend of at least two different compounds, for example at least three or at least four different compounds. In some embodiments the solvent comprises a blend of at least two different organic carbonate compounds, for example at least three or at least four different organic carbonate compounds.

In some embodiments the solvent comprises ethylene carbonate in an amount of at least 50 wt % based on the total weight of solvent, for example at least 55 wt %, at least 60 wt % or at least 65 wt %. In some embodiments the solvent comprises ethylene carbonate in an amount of up to 80 wt % based on the total weight of solvent, for example up to 75 wt % or up to 70 wt %. In some embodiments the solvent comprises ethylene carbonate in an amount of from 50 to 80 wt % based on the total weight of solvent, for example from 65 to 75 wt %.

In some embodiments the solvent comprises propylene carbonate in an amount of at least wt % based on the total weight of solvent, for example at least 15 wt %, at least 20 wt % or 10 at least 22 wt %. In some embodiments the solvent comprises propylene carbonate in an amount of up to 35 wt % based on the total weight of solvent, for example up to 30 wt % or up to 25 wt %. In some embodiments the solvent comprises propylene carbonate in an amount of from 10 to 35 wt % based on the total weight of solvent, for example from 20 to 25 wt %.

In some embodiments the solvent comprises vinylene carbonate in an amount of at least 1 wt % based on the total weight of solvent, for example at least 2 wt %, at least 3 wt % or at least 4 wt %. In some embodiments the solvent comprises vinylene carbonate in an amount of up to 10 wt % based on the total weight of solvent, for example up to 8 wt % or up to 6 wt %. In some embodiments the solvent comprises vinylene carbonate in an amount of from 1 to 10 wt % based on the total weight of solvent, for example from 3 to 6 wt %.

In some embodiments the solvent comprises fluoroethylene carbonate in an amount of at least 1 wt % based on the total weight of solvent, for example at least 1.5 wt %, at least 2 wt % or at least 2.5 wt %. In some embodiments the solvent comprises fluoroethylene carbonate in an amount of up to 10 wt % based on the total weight of solvent, for example up to 5 wt % or up to 3 wt %. In some embodiments the solvent comprises fluoroethylene carbonate in an amount of from 1 to 10 wt % based on the total weight of solvent, for example from 2 to 4 wt %.

In some embodiments, the liquid electrolyte further comprises one or more lithium salts. Examples of suitable lithium salts include LiPF₆, LiBF₄, lithium bis (fluorosulfonyl) imide (LIFSI) and lithium bis (trifluoromethanesulfonyl) imide (LiTFSI).

In some embodiments, the liquid electrolyte comprises one or more lithium salts selected from LiPF₆, LiBF₄, lithium bis (fluorosulfonyl) imide (LiFSI), lithium bis (trifluoromethanesulfonyl) imide (LiTFSI) and lithium 2-trifluoromethyl-4,5-dicyanoimidazole (LiTDI). In some embodiments, the liquid electrolyte comprises a solvent as described above and a lithium salt component comprising or consisting of one or more lithium salts selected from LiPF₆, LIBF₄, LIFSI, LITFSI and LiTDI. In some embodiments, the liquid electrolyte comprises a solvent as described above and a lithium salt component comprising or consisting of one or more lithium salts selected from LiFSI and LiTDI.

In some embodiments, the liquid electrolyte comprises or consists of an organic solvent and an alkali metal salt; wherein the organic solvent consists of one or more of ethylene carbonate, propylene carbonate, dimethyl carbonate, diethyl carbonate, ethyl-methyl carbonate, butylene carbonate, vinylene carbonate, fluoroethylene carbonate, fluoropropylene carbonate and γ-butyrolactone; and the alkali metal salt consists of one or more of LiPFs, LiBF₄, LIFSI, LiTFSI and LiTDI. In some embodiments, the liquid electrolyte comprises or consists of an organic solvent and an alkali metal salt: wherein the organic solvent consists of one or more of ethylene carbonate. propylene carbonate, vinylene carbonate and fluoroethylene carbonate; and the alkali metal salt consists of one or more of LiFSI and LiTDI.

In some embodiments, the liquid electrolyte comprises a mixture of at least two different lithium salts. In some embodiments the solvent comprises a blend of at least two different organic carbonate compounds, for example at least three or at least four different organic carbonate compounds, and the liquid electrolyte comprises a mixture of at least two different lithium salts.

In some embodiments, the concentration of the lithium salt in the organic solvent is at least 10 wt %, based on the total weight of liquid electrolyte, for example at least 11 wt %, at least 12 wt %, at least 13 wt %, at least 14 wt % or at least 15 wt %. In some embodiments, the concentration of the lithium salt in the organic solvent is up to 50 wt %, based on the total weight of liquid electrolyte, for example up to 40 wt %, up to 30 wt %, up to 25 wt % or up to 24 wt %.

In some embodiments, the concentration of the lithium salt in the organic solvent is from 10 to 30 wt %, based on the total weight of liquid electrolyte, for example from 12 to 25 wt % or from 15 to 25 wt %.

In some embodiments, the polymer-electrolyte gel matrix phase makes up from 20 vol % to 50 vol % of the electrode precursor composition, for example from 25 vol % to 45 vol %, from 28 vol % to 42 vol %, from 30 vol % to 40 vol %, from 31 vol % to 49 vol % or from 32 vol % to 48 vol %.

The benefits of the invention based on the specific multimodal particle size distribution of the active material may be achieved for any active material which could be present in an electrode composition. The skilled person will be aware of a large number of possible electrochemically active materials, including cathode active materials (also called positive active materials) and anode active materials (also called negative active materials), which may be used in the present invention.

The electrochemically active material is a particulate material, i.e. a material made up of a plurality of discrete particles. The particles may comprise primary particles and/or secondary particles formed from the agglomeration of a plurality of primary particles.

In some embodiments, the electrochemically active material is a positive active material.

In some embodiments, the positive active material is a lithium transition metal oxide material. In some embodiments, the positive active material is a lithium transition metal oxide material comprising a mixed metal oxide of lithium and one or more transition metals, optionally further comprising one or more additional non-transition metals. In some embodiments, the positive active material is a lithium transition metal oxide material comprising lithium and one or more transition metals selected from nickel, cobalt and manganese. In some embodiments, the positive active material is selected from one or more of lithium cobalt oxide (LCO), lithium manganese oxide (LMO), lithium nickel cobalt oxide (NCO), aluminium-doped lithium nickel cobalt oxide (NCA), lithium nickel manganese cobalt oxide (NMC), lithium nickel oxide (LNO), lithium nickel manganese oxide (LNMO), lithium iron phosphate (LFP), lithium manganese iron phosphate (LFP) and lithium nickel vanadate (LNV). In some embodiments, the positive active material is lithium nickel manganese cobalt oxide (NMC), optionally doped with another metal such as aluminium.

In some cases, the electrochemically active material may comprise carbon, suitably graphite, graphene or a blend of carbon and a silicon oxide.

Such electrochemically active materials are commercially available or may be manufactured by methods known to the skilled person, for example through the precipitation of mixed metal hydroxide intermediates from a reaction mixture containing different precursor metal salts, followed by calcination to form a mixed metal oxide and optionally lithiation to incorporate lithium into the oxide.

The electrochemically active materials may be undoped or uncoated, or may contain one or more dopants and/or a coating. For example, the electrochemically active material may be doped with small amounts of one or more metal elements. The electrochemically active material may comprise a carbon coating on the surface of the particles of the material.

In some embodiments, the electrochemically active material is a negative active material.

In some embodiments, the electrochemically active material has a bimodal particle size distribution.

The polymer-electrolyte gel matrix phase comprises a gel matrix formed by the swelling of the swellable polymer blend when the polymer blend absorbs a liquid electrolyte. The polymer-electrolyte gel matrix phase therefore comprises a gel comprising the polymer blend and absorbed liquid electrolyte.

The polymer blend comprises a blend of the first polymer and the second polymer, wherein the first polymer has a solubility in the liquid electrolyte which is higher than the solubility of the second polymer in the liquid electrolyte.

The skilled person will understand that the relative solubilities of the first and second polymers in the liquid electrolyte will depend on the choice of liquid electrolyte and/or choice of the components of the liquid electrolyte (e.g. solvent).

In general, the first (more soluble) polymer is present to improve the processability of the electrode precursor composition due to its superior gel-forming properties. On the other hand, the second (less soluble) polymer performs a structural function in the finished gel electrode and is present due to the improved structural properties it provides despite its reduced gel-forming capabilities.

In some embodiments, the first polymer exhibits spontaneous dissolution in the liquid electrolyte at room temperature. This may, depending on the polymer, be a very slow process, but in some embodiments exposing the liquid electrolyte to the polymer at room temperature without any specific mixing leads to the formation of a gel.

In some embodiments, the first polymer requires an additional energy input to initiate dissolution, but the result is a material in a very stable homogenous state at room temperature. In some embodiments, dissolution of the first polymer in the liquid electrolyte at elevated temperature (for example, at or greater than 30° C., at or greater than 50° C. or at or greater than 80° C.) is quick and forms a gel which is very stable at room temperature.

Stability of the gel can be evaluated using a number of methods:
A visual assessment would indicate a single phase of material for a stable gel, with no evident liquid-rich phases on the surface;
An optical assessment via microscopy or similar would not show any evidence of phase separation;
Further analytical assessment, for example by DSC, spectroscopy methods including FTIR, RAMAN, or EDX, or x-ray diffraction, would indicate homogenous, single phase mixtures.

In some embodiments, the second polymer exhibits no tendency to swell or dissolve in the liquid electrolyte at elevated temperatures.

In some embodiments the second polymer shows no obvious change of physical state when exposed to the liquid electrolyte at high temperatures, even when utilising high shear mixing techniques. This can be confirmed by a visual assessment which would indicate unchanged polymer when exposed to the liquid electrolyte. In addition, DSC of this mixture would likely show an endothermic melting peak at the same temperature as the raw polymer, indicative that the crystalline polymer phase is unchanged in the material after exposure to the liquid electrolyte.

In some embodiments the second polymer shows partial tendency to swell or dissolve in the liquid electrolyte at elevated temperatures. Slight swelling of the second polymer in the liquid electrolyte in this way may occur, but may be difficult to visually observe. In this case DSC measurements of the mixture may indicate that an endothermic melting peak of the polymer in the mixture is different to that of the raw polymer, indicative of change in crystallinity on exposure to liquid electrolyte.

In some embodiments, the second polymer may show significant swelling and plasticise within the liquid electrolyte but may be unable to take up all of the liquid electrolyte at the desired quantity. A visual assessment would indicate free liquid around the gel revealing this behaviour.

In some embodiments, the second polymer may swell and plasticise with the whole quantity of liquid electrolyte at elevated temperatures, but evaluation of this gel in this state at this temperature might suggest a non-homogenous mixture. For example, rheological assessment of this mixture may be difficult to measure, or noisy, suggestive of inhomogeneous composition or phase separation.

In some embodiments, the second polymer may show the ability to swell or dissolve in the liquid electrolyte at elevated temperatures, but the mixture may not be stable at room temperature. A polymer such as this might swell and plasticise completely with the liquid electrolyte at elevated temperature, but when returned to room temperature it would exhibit behaviour that suggests it is inhomogeneous or unstable. For example, visual assessment of this material may indicate liquid being rejected from a gel mass, as droplets forming on the surface, or pooling around the bulk material.

In some embodiments, the first and second polymers are different from one another and are each independently selected from poly (ethyleneglycol dimethacrylate), poly (ethyleneglycol diacrylate), poly (propyleneglycol dimethacrylate), poly (propyleneglycol diacrylate), poly (methyl methacrylate) (PMMA), poly (acrylonitrile) (PAN), polyurethane (PU), poly (vinylidene difluoride) (PVdF), poly (vinylidene fluoride-co-hexafluoropropylene) (PvDF-HFP), poly (ethylene oxide) (PEO), poly (ethyleneglycol dimethylether), poly (ethyleneglycol diethylether), polychlorotrifluoroethylene (PCTFE), polytetrafluoroethylene (PTFE), poly [bis (methoxy ethoxyethoxide)-phosphazene], poly (dimethylsiloxane) (PDMS), polyacene, polydisulfide, polystyrene, polystyrene sulfonate, polypyrrole, polyaniline, polythiophene, polythione, polyvinyl pyridine (PVP), polyvinyl chloride (PVC), polyaniline, poly (3,4-ethylenedioxythiophene) (PEDOT), poly (p-phenylene), poly (triphenylene). polyazulene, polyfluorene, polynaphthalene, polyanthracene, polyfuran, polycarbazole, tetrathiafulvalene-substituted polystyrene, ferrocene-substituted polyethylene, carbazole-substituted polyethylene, polyoxyphenazine, poly (heteroacene), poly[(4-styrenesulfonyl) (trifluoromethanesulfonyl) imide-co-methoxy-polyethyleneglycolacrylate] (Li[PSTFSI-co-MPEGA]), sulfonated poly (phenylene oxide) (PPO), N,N-dimethylacryl amide (DMAAm), lithium 2-acrylamido-2-methyl-1-propane sulfonate (LiAMPS), Poly (lithium 2-Acrylamido-2-Methylpropanesulfonic Acid-Co-Vinyl Triethoxysilane), polyethyleneoxide (PEO)/poly (lithium sorbate), PEO/poly (lithium muconate), PEO/[poly (lithium sorbate)+BF₃], PEO copolymer, PEO terpolymer, and NIPPON SHOKUBAI® polymer.

The first polymer may be a polymer selected from the list above, and the second polymer may be a different polymer selected from the list above, provided that the first polymer has a solubility in the liquid electrolyte which is higher than the solubility of the second polymer in the liquid electrolyte. Each of the first and second polymers may be formulated from two or more polymers which fit the description of the solubility requirements for each of the first and the second polymer. or example, both polymers could be from the same chemical group, for example PVDF-HFP, but the ratio of chemical groups, or other features of the polymer, such as molecular weight, or order of copolymer groups is sufficiently different to cause the two polymers to exhibit the relative properties of the first and second polymer as previously described.

In some embodiments, the first polymer is selected from poly (methyl methacrylate) (PMMA) and polyethylene glycol (PEG). In other embodiments, the first polymer is selected from PVDF-HFP.

In some embodiments, the second polymer is polyvinylidene fluoride (PvDF). In other embodiments, the second polymer is a functionalised PVDF also called a modified PVDF one examples of which is PVDF-HFP however, the skilled person will be aware of alternative functionalised or modified PVDF polymers.

In some embodiments, the first polymer is selected from poly (methyl methacrylate) (PMMA) and polyethylene glycol (PEG); and the second polymer is polyvinylidene fluoride (PvDF). In some embodiments, the first polymer is poly (methyl methacrylate) (PMMA) and the second polymer is polyvinylidene fluoride (PvDF). In some embodiments, the first polymer is poly (vinylidene fluoride-co-hexafluoropropylene) (PvDF-HFP) and the second polymer is poly (vinylidene difluoride) (PVdF).

In some embodiments, the volume ratio of the first polymer to the second polymer is from 0.75 to 0.85. Such ratios provide particularly stable and processible compositions.

In some embodiments, the electrode precursor composition is for a lithium-ion secondary electrochemical cell. In some embodiments, the electrode precursor composition is a cathode precursor composition.

A second aspect of the invention is an electrode for an alkali metal ion secondary cell comprising:
a polymer-electrolyte gel matrix phase comprising a blend of a first polymer, a second polymer different from the first polymer, and a liquid electrolyte; and
a dispersed phase comprising an electrochemically active material;
   wherein the liquid electrolyte comprises an organic solvent and an alkali metal salt;
   wherein the first polymer has a solubility in the liquid electrolyte which is higher than the solubility of the second polymer in the liquid electrolyte; and
   the volume ratio of the first polymer to the second polymer is from 0.2 to 7.

In some embodiments, the electrode is produced by processing an electrode precursor composition according to the first aspect to form a film.

In some embodiments, the electrode is an extruded electrode. In other embodiments, the electrode is a hot-rolled electrode. In other embodiments, the electrode is prepared by extruding an electrode precursor composition according to the first aspect through a die to form a film.

In some embodiments, the electrode is a cathode.

All of the compositional options and preferences set out above for the electrode precursor composition of the first aspect apply equally to the electrode of the second aspect, including the identities and the relative amounts of the various components of the composition, which do not change during the processing of the precursor composition into the electrode.

In some embodiments, the processing comprises thermal processing or extrusion.

In some embodiments the thermal processing comprises passing the electrode precursor composition through a roller assembly at a temperature of at least 50° C., for example at least 60° C., at least 70° C., at least 80° C., at least 90° C. or at least 100° C. In some embodiments the thermal processing comprises passing the electrode precursor composition through rollers at a temperature of up to 150 ° C., for example up to 140° C. or up to 130° C. In some embodiments the thermal processing comprises passing the electrode precursor composition through rollers at a temperature of from 50° C. to 150° C., for example from 60° C. to 150° C., from 70° C. to 150° C., from 80° C. to 150° C., from 80° C. to 140° C., from 90° C. to 140° C., from 100° C. to 140° C. or from 110° C. to 130° C.

The roller assembly may comprise two rollers separated by a small distance such that the electrode is pressed into a thin film when passed through the rollers.

In some embodiments the thermal processing comprises extruding the electrode. In some embodiments the thermal processing comprises extruding the electrode using an extrusion apparatus comprising one or more screw feeding sections and an extrusion die. In some embodiments, the temperature of the die is at least 50° C., for example at least 60° C., at least 70° C., at least 80° C., at least 90° C. or at least 100° C. In some embodiments the temperature of the die is up to 150° C., for example up to 140° C. or up to 130° C. In some embodiments the temperature of the die is from 50° C. to 150° C., for example from 60° C. to 150° C., from 70° C. to 150° C., from 80° C. to 150° C., from 80° C. to 140° C., from 90° C. to 140° C., from 100° C. to 140° C. or from 110° C. to 130° C.

In some embodiments the electrode has a thickness of less than 150 μm, for example less than 100 μm, less than 90 μm, less than 80 μm or less than 70 μm. In some embodiments the electrode has a thickness of from 40 to 150 μm, for example from 40 to 100 μm, from 40 to 90 μm, from 40 to 80 μm, from 40 to 70 μm or from 50 to 70 μm.

In some embodiments the electrode has a thickness of from 40 to 150 μm, for example from 40 to 100 μm, from 40 to 90 μm, from 40 to 80 μm, from 40 to 70 μm or from 50 to 70 μm.

In some embodiments the electrode has a porosity of less than about 5% by volume. In some cases, the porosity of the electrode is less than 5 vol %, less than 3 vol % or less than 2 vol %. To phrase in another manner, the volumetric density of the electrode may be at least 95%, suitably at least about 97% or 98% of the density of a perfectly non-porous electrode.

In some cases, the extruded electrode may for part of an extruded monolith which includes one or more further layers which are present in an electrochemical battery. For instance, the monolith may include a separator layer, and/or may include the other electrode (i.e. the extruded monolith may include both a cathode and anode). The different layers may be coextruded and have different compositions from one another.

A third aspect of the invention provides an electrochemical secondary cell comprising an electrode according to the second aspect. The cell may be an alkali metal ion secondary cell, for example a sodium-ion secondary cell or a lithium-ion secondary cell. Preferably the cell is a lithium-ion secondary cell. In some embodiments the electrochemical secondary cell comprises a first electrode according to the second aspect, wherein the first electrode is a cathode, and a second electrode according to the second aspect, wherein the second electrode is an anode, and an electrolyte between the cathode and the anode. In some embodiments the electrochemical secondary cell comprises an electrode according to the second aspect laminated with a current collector, for example a metallic foil.

A fourth aspect of the invention provides an electrochemical energy storage device comprising an electrochemical secondary cell according to the third aspect. In some embodiments, the electrochemical energy storage device is a battery. In some embodiments, the electrochemical energy storage device is a lithium-ion battery.

A fifth aspect of the invention provides a method of preparing an electrode for an alkali metal ion secondary cell, comprising:
mixing a polymer, an electrolyte and an electrochemically active material to form an electrode precursor composition according to the first aspect; and
thermally processing the electrode precursor composition to form an electrode film.

In some embodiments, the electrode film has a thickness of from 500 to 700 μm.

In some embodiments, the method further comprises cutting the electrode film to form an electrode of predetermined dimensions.

In some embodiments, the method further comprises performing a second thermal processing step on the cut film to reduce the thickness of the film to within a range of 50 to 70 μm.

In some embodiments, the temperature during thermal processing is from 100 to 140° C.

### EXAMPLES

For all samples tested the active material, conductive carbon, polymer and electrolyte were first weighed and mixed by hand until the mixture was even and lump free. This mixture was then fed into a twin-screw extruder with three mixing zones at several intervals. The main body of the twin screw extruder was held at 120 degrees over the mixing zones, with a ramp from 40 degrees from the input port and a drop off to 80 degrees at the exit. After this material was fed into the twin-screw extruder it was collected in the form of a granular mixture.

This granular mixture was then rolled into a thin film. Precursor material was sandwiched between two sheets of mylar and fed through a rolling mill at 120° C., with the roller gap set to ensure the material was pressed to a thickness of 600 μm.

This 600 μm thick precursor film was then cut to 500 mm×10 mm to assess the ability to form a thin film. This section of film was then fed into a hot roller assembly to create a film of target thickness, typically 50-70 μm depending on formulation.

Gel electrode precursor compositions were prepared according to the compositions shown in Table 1:

| | Amount/vol % | | | | |
|---|---|---|---|---|---|
| | | | Comparative | Comparative | Comparative |
| Component | Example 1 | Example 2 | Example 1 | Example 2 | Example 3 |
| NMC Grade #1 | 51.20 | 51.20 | 51.20 | 51.20 | 64.00 |
| NMC Grade #2 | 12.80 | 12.80 | 12.80 | 12.80 | 0 |
| PVDF-HFP | 0.49 | 0.49 | 0.47 | 0.48 | 0 |
| grade 1 | | | | | |
| Secondary | | | | | |
| polymer | | | | | |
| PVDF-HFP | 0 | 1.70 | 3.32 | 3.38 | 0 |
| grade 2 | | | | | |
| Secondary | | | | | |
| polymer in | | | | | |
| Electrolyte B, | | | | | |
| Primary | | | | | |
| polymer in | | | | | |
| Electrolyte A | | | | | |
| PMMA grade 1 | 3.41 | 1.70 | 0 | 0 | 8.53 |
| Primary | | | | | |
| polymer | | | | | |
| Conductive | 0.97 | 0.97 | 1.89 | 1.29 | 1.89 |
| carbon additive | | | | | |
| grade 1 | | | | | |
| Electrolyte A | 31.14 | 31.14 | 0 | 30.86 | 25.58 |
| Electrolyte B | 0 | 0 | 30.32 | 0 | 0 |

### Electrolytes A and B had the Following Compositions:

Amount/wt %

| Component | Electrolyte A | Electrolyte B |
|---|---|---|
| LiFSI | 20.258 | 12.5 |
| LiTDI | 3.2 | 3.2 |
| Ethylene carbonate | 52.81 | 58.2 |
| Propylene carbonate | 17.6 | 19.4 |
| Vinylene carbonate | 4.08 | 4.4 |
| Fluoroethylene carbonate | 2.04 | 2.2 |

Each of the electrode precursor compositions in Table 1 were formed into a gel electrode film by the method set out above.

The gel electrode formed from the Example 1 composition had a high concentration of electrolyte and showed good cohesion, good adhesion, and good liquid retention.

The gel electrode formed from the Example 2 composition also had a high concentration of electrolyte and showed good cohesion, good adhesion, and good liquid retention.

The gel electrode formed from the Comparative Example 1 composition had a lower concentration of electrolyte than Example 1 or 2. It was not possible to form a stable, processible composition with an electrolyte content equivalent to Example 1 or 2.

This demonstrates that including a primary polymer for solubility in the material composition enables a higher concentration of electrolyte to be used. In this case, PVDF-HFP grade 2 is a primary polymer in electrolyte A, but a secondary polymer in electrolyte B. Therefore in the case of Example 1 and Example 2 it is necessary to include PMMA grade 1 into the formulation as a primary polymer.

The Comparative Example 2 composition was possible to process into an electrode under some conditions, but the result was an electrode with observable defects. There was liquid separation from the electrode on hot rolling. The electrode contained structural defects and a higher porosity than desirable. When tested in a cell under standard conditions, the current collector was often destroyed. This demonstrates that the secondary polymer alone is produces an unprocessible film

The Comparative Example 3 composition showed good electrolyte retention and ease of processability when made into a film, but the film was tacky and left residue on the counter-film backing, indicative of poor cohesion. A streaky pattem was observable in the material which was evidence of liquid flow through the film, indicative of poor structural robustness. A cathode made from the composition and tested in a cell under standard conditions showed poor stability due to dissolution of the PMMA polymer. This demonstrates that the primary polymer alone is insufficient for electrode stability

### New Example

This is to demonstrate that PVDF-HFP can be considered both a primary polymer and a secondary polymer

| | Amount % v/v | |
|---|---|---|
| | Example 4 | Example 5 |
| | EGC-014 (internal code, not | EGC-017 (internal code, not |
| Component | for final draft) | for final draft) |
| NMC grade 3 | 55 | 55 |
| PVDF-HFP grade 3 | 8.58 | 7.5 |
| (Primary polymer) | | |
| PVDF-HFP grade 1 | | 1.07 |
| (Secondary polymer) | | |
| Conductive carbon additive | 2.07 | 2.07 |
| grade 1 | | |
| Electrolyte C | 34.34 | 34.34 |

### Electrolyte C Composition

| Component | Amount % w/w |
|---|---|
| EC | 55.88 |
| PC | 18.63 |
| VC | 4.8 |
| LiTFSI | 19.1 |
| LiBF4 | 1.6 |

Example 4 was shown to be processible into a film at target thickness and was shown to be able to retain electrolyte during processing. However, further assessment of this film demonstrated that the cohesion and adhesion of this film was poor. In this case the poor structural properties of the film render it unviable as an electrode.

Example 5 was shown to be processible into a film at target thickness and shown to be able to retain electrolyte during processing, in addition it was shown to have good cohesion and adhesion.

1. An electrode precursor composition for an alkali metal ion secondary cell, comprising:
a polymer-electrolyte gel matrix phase comprising a blend of a first polymer, a second polymer different from the first polymer, and a liquid electrolyte; and
a dispersed phase comprising an electrochemically active material;
wherein the liquid electrolyte comprises an organic solvent and an alkali metal salt;
wherein the first polymer has a solubility in the liquid electrolyte which is higher than a solubility of the second polymer in the liquid electrolyte; and
a volume ratio of the first polymer to the second polymer is from 0.2 to 7.

2. The electrode precursor composition according to claim 1, wherein the first polymer is a member selected from the group consisting of poly (methyl methacrylate) (PMMA), polyethylene glycol (PEG) and PVDF-HFP.

3. The electrode precursor composition according to claim 1, wherein the second polymer is polyvinylidene fluoride (PvDF) or a PvDF copolymer.

4. The electrode precursor composition according to claim 1, wherein the liquid electrolyte is at least 31 vol % of the electrode precursor composition.

5. The electrode precursor composition according to claim 1, wherein the volume ratio of the first polymer to the second polymer is from 0.75 to 0.85.

6. The electrode precursor composition according to claim 1, wherein the electrochemically active material is a positive active material.

7. The electrode precursor composition according to claim 6, wherein the electrochemically active material is a lithium transition metal oxide material.

8. The electrode precursor composition according to claim 1, wherein the dispersed phase further comprises an electrically conductive additive.

9. The electrode precursor composition according to claim 8, wherein the electrically conductive additive comprises one or more members selected from the group consisting of carbon black and graphite.

10. The electrode precursor composition according to claim 8, wherein the electrically conductive additive is present in an amount of from 0.2 wt % to 2.5 wt %, based on the total weight of electrode precursor composition.

11. The electrode precursor composition according to claim 1, wherein the organic solvent comprises one or more cyclic or linear carbonate compounds.

12. The electrode precursor composition according to claim 1, wherein the organic solvent comprises one or more members selected from the group consisting of ethylene carbonate, propylene carbonate, dimethyl carbonate, diethyl carbonate, ethyl-methyl carbonate, butylene carbonate, vinylene carbonate, fluoroethylene carbonate, fluoropropylene carbonate and γ-butyrolactone.

13. The electrode precursor composition according to claim 1, wherein the alkali metal salt comprises one or more members selected from the group consisting of LiPF₆, LiBF₄, lithium bis (fluorosulfonyl) imide (LiFSI), lithium bis (trifluoromethanesulfonyl) imide (LiTFSI) and lithium 2-trifluoromethyl-4,5-dicyanoimidazole (LiTDI).

14. The electrode precursor composition according to claim 1, wherein the concentration of the alkali salt in the organic solvent is from 10 to 30 wt %, based on the total weight of liquid electrolyte.

15. The electrode precursor composition according to claim 1, wherein the electrode precursor composition comprises from 50 to 75 vol % of the electrochemically active material, based on the total composition volume.

16. The electrode precursor composition according to claim 1, wherein the electrochemically active material makes up at least 60 vol % of the electrode precursor composition.

17. The electrode precursor composition according to claim 1, wherein the electrode precursor composition comprises from 20 vol % to 50 vol % of the polymer-electrolyte gel matrix phase, based on the total composition volume.

18. The electrode precursor composition according to claim 1, wherein the polymer-electrolyte gel matrix phase comprises 5 to 30 vol % polymer, based on the total volume of polymer-electrolyte gel matrix phase.

19. (canceled)

20. (canceled)

21. An electrode for use in an alkali metal ion secondary cell comprising:
a polymer-electrolyte gel matrix phase comprising a blend of a first polymer, a second polymer different from the first polymer, and a liquid electrolyte; and
a dispersed phase comprising an electrochemically active material;
wherein the liquid electrolyte comprises an organic solvent and an alkali metal salt;
wherein the first polymer has a solubility in the liquid electrolyte which is higher than a solubility of the second polymer in the liquid electrolyte; and
a volume ratio of the first polymer to the second polymer is from 0.2 to 7.

22. (canceled)

23. (canceled)

24. (canceled)

25. A method of producing an electrode comprising processing an electrode precursor composition according to claim 1 to form a film or coating.

26. (canceled)

27. (canceled)
